(19) United States
(12) Patent Application Publication
(10) Pub. No.: US 2006/0252623 A1
(43) Pub. Date: Nov. 9, 2006

(54) Method of converting web or sheet material and press for applying said method

(75) Inventors: Jean-Claude Rebeaud, Le Mont (CH); Andre Vessaz, Penthalaz (CH)

Correspondence Address: OSTROLENK FABER GERB & SOFFEN, 1180 AVENUE OF THE AMERICAS, NEW YORK, NY, 100368403, US

(73) Assignee: Bobst S.A.

(21) Appl. No.: 11/418,529

(22) Filed: May 3, 2006

(30) Foreign Application Priority Data
May 3, 2005 (EP) 05405334.3

(51) Int. Cl. B31B 1/62

(52) U.S. Cl. 493/143

(57) ABSTRACT

A method for curvilinearly converting of web or sheet material by compression of the material between an upper table and a lower table. The tables are each connected to a respective supporting structure and operate conjointly on either side of the plane of travel of the material along a longitudinal axis. During the compression phase, there is a phase of essentially unidirectional intentional elastic deformation of a structure of one of the tables. The deformation increases and then decreases as the curvilinear surface of one table rolls past the other table, for providing generally more uniform compression as the surface rolls. An apparatus for the compression includes the structure described.

### BACKGROUND OF THE INVENTION

The present invention relates to a method of converting web or sheet material by compression between an upper table and a lower table, and to a converting press for applying the method.

Such presses are known particularly in the field of paper or board converting for making things such as folding boxes.

One kind of press, well known to those skilled in the art, operates on the paper or board material by converting it flat between two platens, one fixed and the other moving as described for example in EP0681892. The fixed platen is an upper table connected to the machine frame. For cutting presses, the cutting tool mounted on this fixed platen is a plate provided with a multitude of knives for cutting and compressing the material to a desired shape. This plate is generally known to those skilled in the art as a cutting form. The moving platen is provided with opposing elements acting as an anvil and with negative indentations for the compressing knives or knife lines. The moving platen itself takes the form of a lower table connected to a supporting structure. In the version described in EP0681892, the lower table is moved vertically in a cyclical manner. In other known versions, the lower table is fixed while the upper table is moved vertically in a cyclical manner. This periodic movement has the effect of compressing the material processed between the two platens, thus cutting and/or compressing it in a brief operation covering its entire surface.

The flat cutting of an area equivalent to that of a cutting platen requires the use of considerable compressive force. If the knives of the cutting form are not to be rapidly blunted, care must also be taken to ensure that the knives do not press more than is necessary against the anvil as they cut the material sandwiched between the two platens. Depending on the thickness and type of material converted, different settings are required, including one setting to refine the quality of the cutting by adjusting the height of the knives in areas where the material has not been sufficiently well cut. For this purpose the machine operator places a depth-adjusting sheet on the back of the knives of the cutting form. This depth-adjusting sheet is designed to have small pieces of adhesive tape stuck to the above-mentioned areas. In this way, when the material is compressed between the two tables, converting of the material will be more satisfactory because of the variation in height of the cutting edge of the knives relative to the sole plate of the upper table.

One of the disadvantages of this practice is that this depth-adjusting operation is relatively time-consuming and requires several successive trials before a satisfactory result is achieved. The time spent on this operation is currently the longest part of the operation of preparing the machine for a new job. For short runs, this is a non-negligible amount of time and therefore tends to increase production costs.

A second type of press known at the present time rotary converts the stock between two cylinders pressed against each other. The upper cylinder generally comprises a circular cutting tool, which has a development that corresponds to the selected shape to be cut. The lower cylinder is a smooth cylinder that acts as a cylindrical anvil. Such a machine is illustrated for example in EP1331054.

A third type of press uses a flat upper table and a moveable lower table of curvilinear shape. Because of the rounded surface of the moveable table, cutting of the material takes place progressively by movement of the lower table by its rolling against the cutting plane of the fixed upper table. Such a curvilinear cutting press is described in GB914637.

Although this latter method of cutting has the advantage of reducing the force necessary to convert the material, it has been observed that the knives of the cutting form which is attached to the upper platen wear rapidly and unevenly. Inspection has shown that knives situated in the center of the cutting form become blunter much faster than knives at the upstream and downstream ends of this tool. This anomaly is essentially due to the method of curvilinear cutting in which the forces employed are twice as great in the center of the platen as at its ends supported by the moving structure of the lower table. These problems require frequent replacement of the knives, cause production of poorer-quality products and require numerous machine stoppages while the cutting form is reconditioned. For specialists in the area, these are the main reasons which prevented the development of curvilinear converting presses, which have never worked satisfactorily, unlike the other two types of presses that use flat cutting and rotary cutting.

### SUMMARY OF THE INVENTION

It is an object of the present invention to solve, at least in part, the above-mentioned problems so that on the one hand it will no longer be necessary to use a depth-adjusting operation, and on the other hand the necessary force applied to the converting tools will be as constant as possible to avoid premature deterioration of these tools.

The invention comprises method for curvilinearly converting of web or sheet material by compression of the material between an upper table and a lower table. The tables are each connected to a respective supporting structure and operate conjointly on either side of the plane of travel of the material along a longitudinal axis. During the compression phase, there is a phase of essentially unidirectional intentional elastic deformation of a structure of one of the tables. An apparatus for the converting includes the structure described above. The deformation increases and then decreases as the curvilinear surface of one table rolls past the other table, for providing generally more uniform compression as the surface rolls.

A clearer understanding of the invention will be gained from a study of a preferred but in no way restrictive embodiment illustrated by the accompanying figures.

### BRIEF DESCRIPTION OF THE DRAWINGS

FIG. 1 is a diagrammatic side view of one embodiment of a press according to the invention;

FIG. 2 is a diagrammatic perspective view of an upper table of a press seen from above;

FIG. 3 is a diagrammatic perspective view of a lower table of a press seen from below;

FIG. 4 is a diagrammatic longitudinal section through a table formed by a structure in accordance with a second embodiment; and

FIG. 5 is a schematic representation in the form of three diagrams illustrating respectively the stiffnesses in the supporting structure of a nondeformable table, the stiffness in an intentionally deformable table, and the combination of these stiffnesses as they occur in the press of the present invention.

### DESCRIPTION OF PREFERRED EMBODIMENTS

From a terminological point of view, and to avoid any confusion in the following description, the terms upstream and downstream are defined with reference to the direction of movement of the web or sheet material, as illustrated by an arrow D in the figures. This material moves from upstream to downstream following the main axis of the machine in a movement marked by periodic stops. The terms longitudinal and transverse are defined with reference to the main axis of the machine. Furthermore, in order not to overburden the description by mentioning details of construction that have no direct relevance to the invention and are well known to those skilled in the art, the terms upper table and lower table denote all those elements situated on the respective side of the material and which cooperate to convert the material.

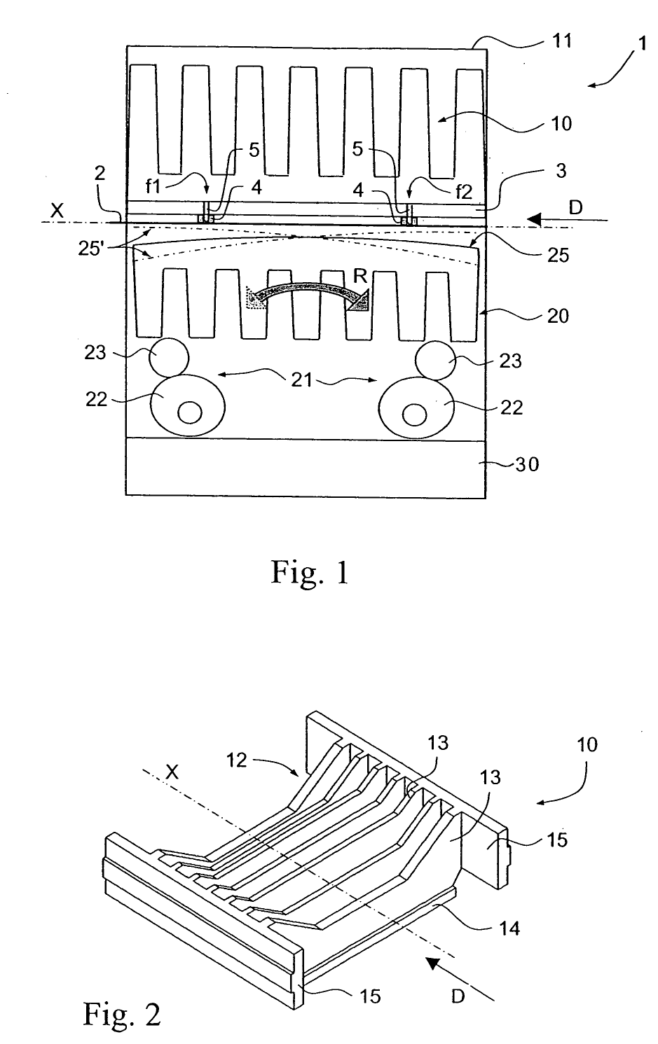

FIG. 1 shows a press 1 for processing a web or sheet material 2 traveling in the direction of movement illustrated by the arrow D. On the respective sides of the plane of travel of longitudinal axis X, there are an upper table 10 and a lower table 20. Each of these tables is connected to a respective supporting structure 11 and 21. The supporting structure of the upper table 10 is the frame of the press 1, while that of the lower table 20 is comprised of the members which support and move the lower table relative to a crossmember 30, which acts as a pedestal or base for the press.

The fixed upper table is arranged a short distance above the plane along which the material 2 advances. It is equipped with a converting tool 3, which is the cutting form in the case of a press designed for cutting and compressing the processed material. Arranged on this cutting form are a plurality of converting members 5 for the material 2, which are thus made integral with the upper table, more generally one of the tables 10, 20, or at least one of them. The converting members each extend transversely across the table and are spaced apart along the direction D. Although two converting members 5 are illustrated in FIG. 1, use of more is also contemplated. Typically, such converting members 5 are, for example, cutting and/or compressing knives arranged between rubber strips or other strips of resilient material 4. The purpose of these strips is both to protect the knives and to provide a surface which contacts and immobilizes the material when the material is squeezed between the two tables. The line running transversely level with the most downstream knife (with reference to the direction of movement D of the material) is termed the first knife line f1. Conversely, the line running transversely level with the last or most upstream knife is termed the last knife line f2.

The supporting structure 21, formed for example by cams 22 and rollers 26, imparts to the lower table 20 a relatively complex vertical and scything movement, part of which causes its work surface 25 to roll with a pressing action against the upper table 10. The material and the cutting form are sandwiched between these two tables and the cutting knife lines over which the work surface rolls cut through the material. The direction of rotation of the moving table is indicated in FIG. 1 by the arrow R, which during compression of the material 2 pivots preferably from the downstream end to the upstream end, and from the upstream end to the downstream end when the moving table is lowered to allow the processed material to move forward briefly again.

The alternating tilting movement of the work surface 25 is illustrated in this same figure by the dot-dash lines 25′. This movement cuts the material 2 progressively without distorting it. The technique of curvilinear cutting allows much smaller forces to be used than are required to achieve the same result in a machine designed for flat cutting. In addition, the pressure exerted is generally smaller. This is because a machine employing the flat cutting technique must exert a minimum amount of pressure at all cutting or compressing points across the entire area of the material to be processed. An increased average pressure is therefore applied in order to make certain that the minimum pressure is being applied at all points, which of course increases the forces involved. In the curvilinear cutting technique the work surface is rolled over the cutting knife lines, so the cutting area at any given instant is smaller and the forces involved are thus considerably reduced.

A converting press applying the method according to the invention can therefore be substantially lighter than the existing machines that use a flat cutting and compressing process. The drive system and the frame can therefore be redesigned and made smaller than those of a flat converting machine. A press according to the invention is therefore less expensive to produce, ship and install.

The curvilinear cutting and compressing converting presses found in the prior art are all based on the same principle as flat converting presses. In these presses the frame and tables are therefore designed to be as rigid as possible so that they suffer the least possible amount of deformation during the converting process.

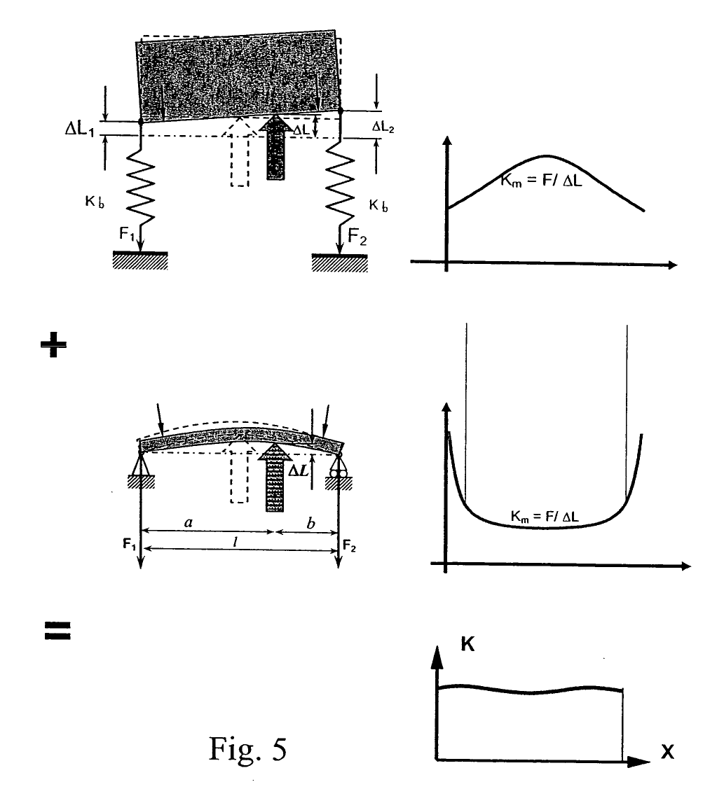

FIG. 5 gives an illustration, in the form of diagrams, of the notions of forces, stiffnesses and deformations that occur in the supporting structure 11 and in the upper table 10, depending on the position of the force F generated by the compression of the lower table 20 against the upper table. This figure helps in particular to explain why in known curvilinear cutting machines of the prior art the converting tools suffer abnormal wear.

The diagrammatic representation of this figure is based on modeling the elastic resistances calculated for a curvilinear cutting press such as that described with reference to FIG. 1. Because of the curvilinear movement of the moving table, the force F exerted by this table therefore travels from the downstream end to the upstream end along the longitudinal axis X during the time it takes to convert the material.

The diagram illustrated on the left-hand side of FIG. 5 represents an upper table of the prior art in the form of a rigid beam connected at its ends to its supporting structure, that is to the press frame. Though theoretically not flexible, this frame unavoidably has a certain intrinsic elasticity when subjected to a large stress. Behaving like a spring, it therefore possesses a certain intrinsic stiffness K_{frame}. This stiffness is exactly like the constant with a spring which is determined by the ratio of the increase in the applied force to the resulting elongation. In our case, the elongation corresponds to the deformation of the frame under the action of the force applied to the frame, as compared with its rest condition corresponding to when the lower table is withdrawn.

Staying with the left-hand graph which shows the variation of the stiffness K_{frame} as a function of the position of the force F along the longitudinal axis X, it will be seen that this stiffness increases progressively as soon as the lower table comes into action to cut the material. This progression continues until it reaches a maximum halfway through its curvilinear course along the upper table. The stiffness then declines progressively in the same way as it had increased, until it reaches its initial value. Because the resultant of the two stiffnesses when placed parallel corresponds to the sum of the stiffnesses, the maximum value is therefore twice the initial value. The corresponding force applied to knives situated halfway between the first knife line f1 and the last knife line f2 is also therefore twice that applied at the ends of the cutting form. This is why the knives of tools fitted to machines of the prior art wore not only too rapidly but also unevenly.

To solve this problem the converting method according to the present invention comprises a phase of intentional and essentially unidirectional elastic deformation of a structure belonging to at least one of the tables, during the phase of compression of the material between the tables. These deformations are advantageously oriented essentially perpendicularly to the work surface. It should be noted that the intentional nature of these deformations is clearly aimed at differentiating them from involuntary deformations such as occur within the same structure in the transverse or longitudinal directions in particular. Hence, the use of the adverb “essentially” is intended to make it clear that the deformations that occur are almost entirely unidirectional.

In terms of forces, deformation and stiffnesses, the converting method according to the invention is illustrated in the next two diagrams of FIG. 5. The middle diagram shows the reaction of an upper table 10 of a converting press according to the present invention, connected at each end to a rigid supporting structure.

In this example the upper table 10 is capable of experiencing intentional elastic deformations essentially perpendicular to the work surface, because of the flexibility of its structure. Its intrinsic stiffness K will therefore vary between its ends along the longitudinal axis X. The stiffness, or elastic resistance, of the upper table 10 will be greater at its ends than in an intermediate position between these ends. By careful design of the structure 12 of the upper table 10, the variation of its stiffness can be made to almost cancel out the increase in stiffness seen in the diagram on the left, giving an almost constant final stiffness as shown in the last diagram on the right-hand side of FIG. 5. The force applied to the converting members 5 of such a press 1 does not therefore undergo large fluctuations, but rather is as constant as it can be during the converting of the material.

Computer modeling has made it possible to compare the forces along a series of knives in a cutting form fitted first to an ordinary platen press, and then to a press according to the invention. The results show that the ratio of the minimum force to the maximum force found at all measured points in a curvilinear cutting press according to the present invention is at least five times better than when cutting with an ordinary press. This demonstrates the great improvement in terms of evenness of the converting force across the whole of the area of the cutting form.

From a practical point of view, it should be observed that the stiffness compensation has the result of making the force per unit length of the converting members 5, particularly the knives, practically constant as the moving table rolls against the fixed table. The near constancy of this force is of real interest only in the range situated between the first knife line f1 and the last knife line f2. It would also therefore be quite adequate to obtain effective compensation in this region only.

FIG. 2 shows an embodiment of the structure 12 of the upper table 10 seen in perspective in a top view. Notice that this structure is elastic and anisotropic so that it only allows itself to be deformed along the longitudinal axis X, in a direction perpendicular to the work surface.

Thus, transverse deformations will be kept as low as possible by reinforcing members 13 in this structure, and particularly by the way in which they are positioned relative to the longitudinal axis X of travel.

Advantageously, these reinforcing members are on the one hand laid in an essentially transverse orientation relative to this axis, and on the other hand placed on edge, against a sole plate 14, and thus have the greatest possible resistance to bending in this orientation. The reinforcing members preferably consist of ribs whose ends are connected to the side walls of the frame of the press, either directly, or indirectly via side plates 15. While on this subject, notice that the connection may be achieved in some other way and that, for example, it is not necessary for the entire height of the rib to be connected.

Thus, it will be observed in FIG. 2 that the thicknesses, heights, shapes or outlines of the reinforcing members 13 can vary so as to influence the bending of the upper table 10 as a function of the position, along the longitudinal axis X, of the force applied by the lower table 20. The spacing between these reinforcing members is also an influencing factor, as is an optional deliberate non-perpendicularity with respect to the longitudinal axis of travel of the material. In a similar way, note that the connection or attachment of the edge of the reinforcing member 13 to the sole plate 14 may also have a particular shape in order to influence the behavior of the upper table when it is bent. As illustrated in FIG. 2, this sole plate is preferably not directly attached to the side plates 15. In order to permit only bending of the table in the longitudinal direction, the structure 12 is advantageously neither closed, nor provided with cross ribs deliberately intended to prevent this bending.

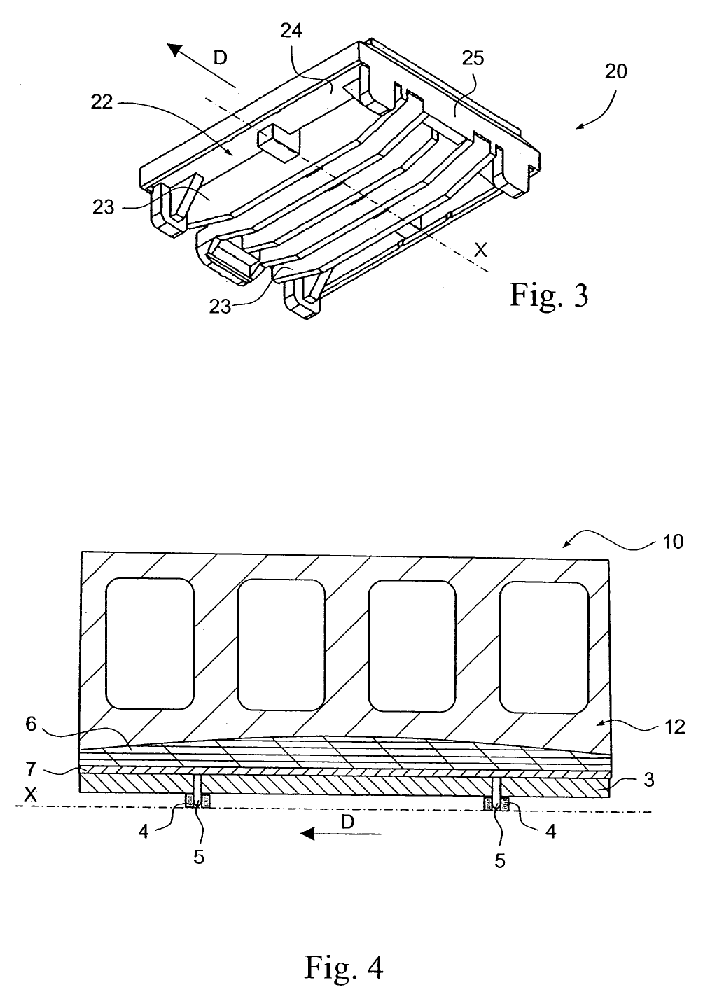

Referring to FIG. 3, this figure shows an embodiment of the structure 22 of the lower table 20, shown in perspective in a view from beneath. This embodiment and its characteristics are similar to those described above with reference to the upper table 10. Thus, this structure also has the same members as those of the structure 21, namely reinforcing members 23, a sole plate 24 and side plates 25, the exception being that because of the mobility of the lower table 20, the side plates will not of course be connected to the frame of the press 1.

FIG. 4 shows, in a longitudinal section, a second embodiment of the structure 12 of one of the tables, in particular of the upper table 10. Unlike that described in the previous embodiment, this structure is not necessarily open and contains no reinforcing member of the rib type. In this structure the desired elastic deformations are obtained by fitting to the table an elastic sole plate 6 of variable stiffness. This variable stiffness or elastic resistance can be produced by varying the thickness of the elastic sole plate 6 in a selected direction, namely essentially in the direction of the longitudinal axis X. The converting tool 3 is preferably arranged either directly against the elastic sole plate 6 in order to benefit from its intentional deformations, or through an intermediate bearing plate 7 capable of withstanding the aforesaid deformations without ever going outside of the elastic range of the material of which it is made.

In general terms, it will be pointed out that the structure 12, 22 of either or both of the tables 10, 20 of the press 1 is comprised of at least one variable-stiffness member and that this member can be the elastic sole plate 6, for example, though it may also be the reinforcing members 13, 23 as described earlier.

In much the same way, the same reasoning can be applied to the intrinsic stiffnesses employed in the lower table 20. In general terms, it is pointed out that the structures of the lower and upper tables are so designed that the sum of the intrinsic stiffnesses in these tables and in their supporting structures 11, 12 is such that it is close to a value which remains constant as the moving table rolls against the fixed table. In one particular embodiment, the two tables 10, 20 each possess an intentionally deformable elastic structure and undergo combined intentional deformations.

The radius of curvature at all points of the curvilinear work surface is preferably greater than or equal to five times the working distance between the first and last knife lines, thus smoothing out the variations of the load on the compressed material and increasing the length of the compressed zone.

In more general terms, it will also be pointed out that the tasks performed by these presses are not indeed limited merely to cutting and compressing operations but could be accommodated to any other converting operation, such as embossing, applying metallized bands or printing.

Advantageously, the present invention makes it possible to dispense completely with the depth-adjusting operation necessary in ordinary flat converting presses. This both reduces machine preparation time and allows these tasks to be done by less skilled staff.

Also advantageously, the present invention makes it possible to gain the maximum benefit from the advantages of curvilinear converting by allowing the use of lighter presses thereby reducing costs and environmental nuisance, while avoiding premature tool wear. As a result, not only is tool life extended, but also the quality of cutting and scoring by compression of the material are improved by comparison with the output of ordinary platen presses.

What is claimed is:

1. A method for curvilinear converting of web or sheet material by compression between an upper table and a lower table wherein the tables are connected to a supporting structure and the tables work conjointly on either side of the plane of travel of the material along a longitudinal axis, the method comprising compressing the material between the upper and lower tables during a compression phase and during the compression phase, permitting a phase of essentially unidirectional, intentional, elastic deformation of a structure of a first one of the tables.

2. The method according to claim 1, wherein the intentional deformations are essentially oriented perpendicularly to the plane of travel of the material.

3. The method according to claim 1, wherein the compression phase includes a phase of essentially unidirection, intention, elastical deformation of a structure of a second one of the tables, and the two phases of elastic deformation are combined together.

4. The method of claim 1, further comprising the structure of one of the tables is curvilinear and the method comprises rolling the curvilinear structure over the structure of the other table for causing the deformation of the structure of the first one of the tables.

5. The method of claim 4, wherein the one of the tables is elastic such that the deformation thereof increases and then decreases as the curvilinear structure rolls over the structure of the other table for causing the compression to be generally more uniform during the rolling.

6. A press for curvilinear converting of web or sheet material by compression, comprising
an upper table and a lower table, a respective supporting structure for each of the tables and operating conjointly on either side of the plane of travel of the material on a longitudinal axis, at least one of the tables being movable relative to the other table;
a curvilinear work surface supported on one of the tables;
one of the tables comprises at least one variable stiffness member operable to deform elastically intentionally during a compression phase wherein the at least one table moves to compress the material.

7. The press according to claim 6, wherein the one table includes a variable-stiffness elastic sole plate.

8. The press according to claim 6, wherein the one table includes reinforcing members to oppose bending of the one table along an axis transverse of the plane of travel of the material.

9. The press according to claim 8, wherein the reinforcing members have the form of ribs.

10. The press according to claim 6, wherein the one table has an open structure.

11. The press according to claim 6, wherein the movable table supports the curvilinear work surface to roll while applying a pressing action against the fixed table during converting the material.

12. The press according to claim 11, wherein the curvilinear work surface is supported to roll in a direction opposite to the direction of travel of the material.

13. The press according to claim 11, wherein the one of the tables is elastic such that the deformation thereof increases and then decreases as the curvilinear structure rolls over the structure of the other table for causing the compression to be generally more uniform during the rolling.

14. The press according to claim 11, further comprising knives for cutting the material arrayed across the direction of travel at intervals, and each knife at a respective knife line.

15. The press according to claim 6 ,wherein at all points therealong, the curvilinear work surface has a radius of curvature greater than or equal to five times a working distance between a first knife line and a last knife line of the knives.
